(19) United States
(12) Patent Application Publication
(10) Pub. No.: US 2010/0198710 A1
(43) Pub. Date: Aug. 5, 2010

(54) Method, apparatus, and system for implementing prepaid accounting on a network

(75) Inventors: Wei Zhang, Shenzhen (CN); Liang Gu, Shenzhen (CN); Xianhui He, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/758,629

(22) Filed: Apr. 12, 2010

Related U.S. Application Data
(63) Continuation of application No. PCT/CN2008/073133, filed on Nov. 20, 2008.

(30) Foreign Application Priority Data
Nov. 21, 2007 (CN) 200710124664.9
Jun. 4, 2008 (CN) 200810125502.1

(51) Int. Cl. G06Q 10/00; G06F 15/16

(52) U.S. Cl. 705/30; 709/227

(57) ABSTRACT

An embodiment of present invention provides a method for implementing prepaid accounting on a network. The method comprises sending, by a source Anchor data path function (DPF), an Anchor DPF relocation request carrying quota information to a target Anchor DPF; and returning, by the source Anchor DPF, an Anchor DPF relocation acknowledgement message carrying quota compensation information to the target Anchor DPF, when receiving a relocation response sent by the target Anchor DPF. The method for implementing prepaid accounting on a network according to the embodiment of present invention allows the prepaid service to be implemented on the network.

### CROSS-REFERENCE TO RELATED APPLICATIONS

This application is a continuation of International Application No. PCT/CN2008/073133, filed on Nov. 20, 2008, which claims priority to Chinese Patent Application No. 200710124664.9, filed on Nov. 21, 2007 and Chinese Patent Application No. 200810125502.1, filed on Jun. 4, 2008, all of which are hereby incorporated by reference in their entireties.

### FIELD OF THE INVENTION

The present invention relates to the communications field, and particularly, to a method, an apparatus, and a system for implementing prepaid accounting on a network.

### BACKGROUND

Worldwide Interoperability for Microwave Access (WiMAX) is a wireless metropolitan area network (WMAN) technology based on IEEE 802.16 specification. The WiMAX network is mainly composed of three parts, i.e., subscriber terminal (MS), access service network (ASN) and connection service network (CSN). The ASN includes base station (BS) and ASN gateway (ASN GW). The CSN includes logic entities such as policy function (PF), authentication, authorization and accounting server (AAA Server), and application function (AF). Radio side of the WiMAX network is of WMAN access technology based on IEEE 802.16d/e specification. Nowadays, IEEE 802.16-2004 (802.16d) specification set up in July 2004 is complied. The structure of the WiMAX network is shown in FIG. 1.

Interface R1 is a radio air interface that is mainly defined in IEEE802.16d/e, and other interfaces are wired interfaces.

The latest Quality of Service (QoS) framework for WiMAX NetWorking Group (NWG) specification is shown in FIG. 2, with the functional entities described below.

Mobile Station (MS) is a mobile subscriber terminal;
Service Flow Management (SFM) is for establishing a subscriber service flow and assigning radio resources for the service flow. The SFM is located in the ASN;
Service Flow Authorization (SFA) is for authorizing corresponding service flow. The SFA in located in the ASN;
Policy Function (PF) is for providing policy for a certain subscriber service flow. The PF in located in the NSP, and there are Visited PF and Home PF in roaming scenario;
AAA Server is a system for providing authentication, authorization and accounting service. The AAA server stores subscriber's QoS profile and relevant policy rules;
Application Function (AF) is a function entity for application services. The subscriber terminal MS directly accesses the AF through application layer protocol connection, and the AF instructs the PF to initiatively create a service flow for subscriber. The AF in located in the NSP.

FIG. 3 is a schematic diagram of related-art accounting architecture following the WiMAX NWG specification. As shown in FIG. 3, the MS functions as a subscriber terminal during the accounting, and an Accounting Client or Accounting Agent is employed to collect all accounting information and provide to an AAA Proxy or AAA Server (when there is no AAA Proxy). A prepaid client (PPC) is employed to interact with a prepaid server to provide a support to the prepaid service, and the PPC can be integrated with the Accounting Client or the Accounting Agent. The AAA Proxy is an optional intermediate device, for generating new accounting information after processing the received accounting information, and forwarding to the AAA Server, such as Home AAA Server or Visited AAA Server. The Home AAA Server is an AAA server at which the subscriber initially registered or an AAA server at the subscriber's home place. The Home AAA Server stores subscription information of the subscriber including accounting policy, etc. The accounting process for the subscriber is mainly performed in the Home AAA Server. The Visited AAA Server is an AAA server at the subscriber's visited place for implementing functions such as recording, transparent transmitting and forwarding of accounting information when the subscriber roams.

With respect to the implementation of the prepaid function, the current WiMAX NWG protocol defines that the PPC and the Authenticator are located in the same entity, and the PPC functions as a prepaid client to communicate prepaid accounting-related signaling with the PPS. When the PPC is not located in the data plane entity, a prepaid agent (PPA) may be located in the data plane entity. In this case, it is specified that the PPA has a measuring function only, but it is not clearly specified how to implement this function. Because the interaction between the PPA and the PPC is not specified, and the scenario of migration is not considered, the prepaid service cannot be supported when the PPA and the PPC separate from each other.

### SUMMARY OF THE INVENTION

The present invention provides a method, an apparatus, and a system for implementing prepaid accounting on a network, which are capable of supporting prepaid service on a network.

An aspect of the invention provides a method for implementing prepaid accounting on a network, comprising:

sending, by a source Anchor DPF, an Anchor DPF relocation request carrying quota information to a target Anchor DPF; and
returning, by the source Anchor DPF, an Anchor DPF relocation acknowledgement message carrying quota compensation information to the target Anchor DPF, when receiving a relocation response sent by the target Anchor DPF.

Another aspect of the invention provides a method for implementing prepaid accounting on a network, comprising:

sending, by a source prepaid agent (PPA), a relocation request carrying quota information to a target PPA; and
sending, by the source PPA, a relocation acknowledgement message carrying quota compensation information to the target PPA, when receiving a relocation response sent by the target PPA.

Yet another aspect of the invention provides a method for implementing prepaid accounting on a network, comprising:

receiving, by a target prepaid client (PPC), a notification message sent by a source PPC and carrying session information of the source PPC associated with a prepaid service; and
sending, by the target PPC, a request message to a prepaid server (PPS) to request establishment of a new session, where the request message carries the session information of the source PPC and a correlation indication indicating a correlation between the new session to be established and the session of the source PPC.

Yet another aspect of the invention provides a source prepaid agent (PPA), comprising:

a sending module configured to send a relocation request carrying quota information to a target PPA; and
a receiving module configured to receive a relocation response sent by the target PPA, wherein the sending module sends a relocation acknowledgement message carrying quota compensation information to the target PPA after the receiving module receives the relocation response sent by the target PPA.

Yet another aspect of the invention provides a target PPC, comprising:

a notification message receiving module configured to receive a notification message sent by a source prepaid client (PPC), where the notification message carries session information of the source PPC associated with a prepaid service; and
a request message sending module configured to send a request message to a prepaid server (PPS) to request establishment of a new session, where the request message carries the session information of the source PPC and a correlation indication indicating a correlation between the new session to be established and the session of the source PPC.

In the methods for implementing prepaid accounting on a network provided by the embodiments of the present invention, the Anchor DPF or PPA relocation request carries quota information, and the Anchor DPF or PPA relocation acknowledgement message carries quota compensation information, which enables the prepaid service to be implemented on the network.

### BRIEF DESCRIPTION OF THE DRAWINGS

FIG. 1 is a schematic diagram of the related-art WiMAX network;

FIG. 2 is a diagram showing QoS framework of the related-art WiMAX NWG specification;

FIG. 3 is a schematic diagram showing accounting architecture of the related-art WiMAX NWG specification;

FIG. 4 is a flowchart of a method for implementing prepaid accounting in a scenario of Anchor DPF migration according to an embodiment of the present invention;

FIG. 5 is a flowchart of a method for implementing prepaid accounting in a scenario of Authenticator migration according to an embodiment of the present invention;

FIG. 6 is a flowchart of a method for implementing prepaid accounting in a scenario of Authenticator migration according to an embodiment of the present invention.

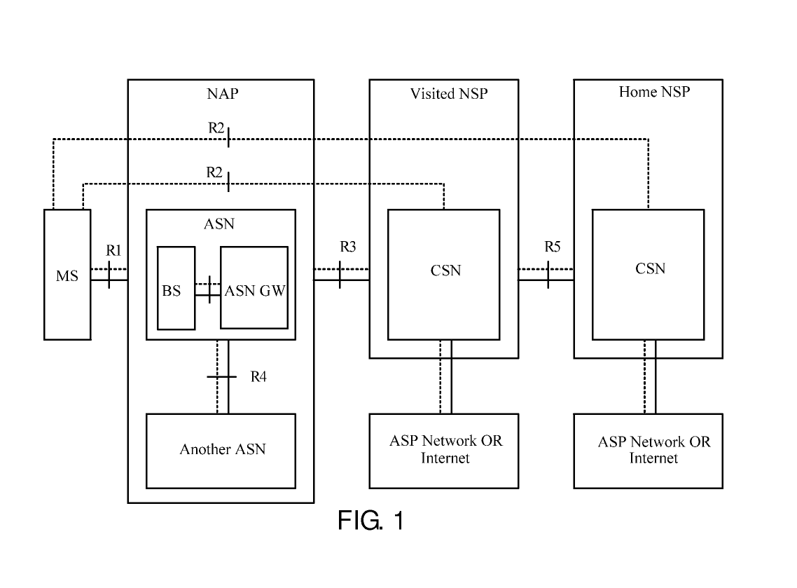

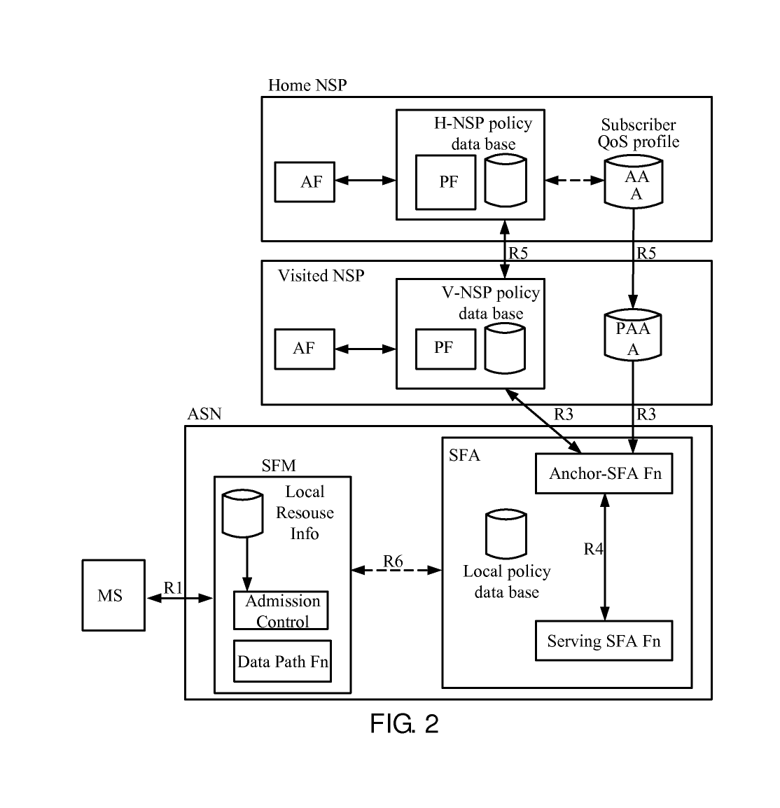

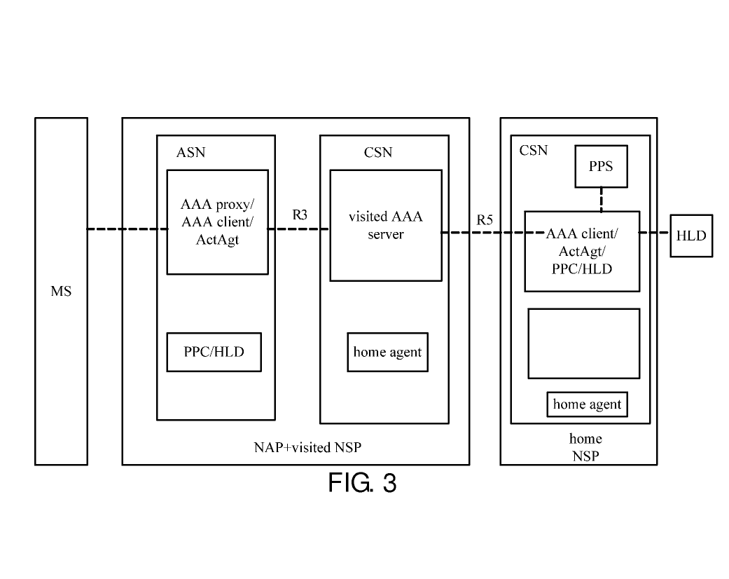

### DETAILED DESCRIPTION OF THE PREFERRED EMBODIMENTS

Embodiments of the present invention are described in detail as follows with reference to the drawings.

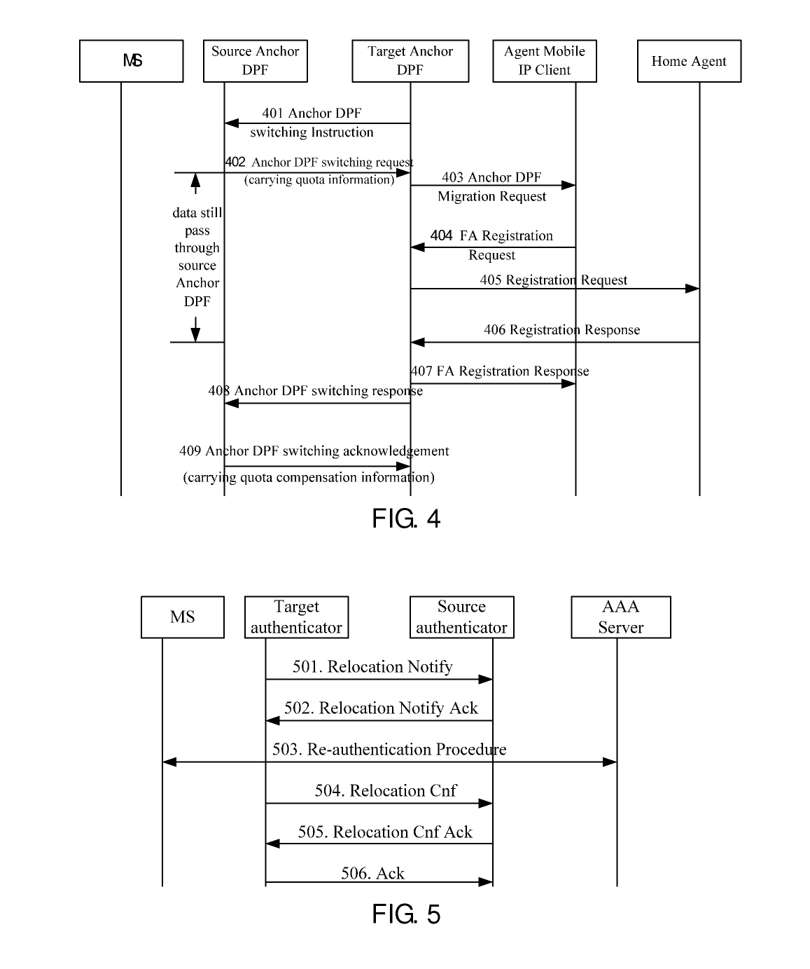

Embodiments of the present invention provide a solution for information enquiry between respective functional entities in a PCC structure. FIG. 4 illustrates a flowchart of a method for information enquiry in a PCC structure according to an embodiment of the present invention, and the method may include steps as described below.

The present invention is further described in conjunction with the drawings and embodiments, but the present invention is not limited by the following embodiments.

With respect to the method for implementing prepaid accounting on a network, the network may be any type of network, such as GSM network, CDMA network, and WiMAX network. In the embodiments of the present invention, a method for implementing prepaid accounting in WiMAX network is taken as an example.

The prepaid client (PPC) and the Authenticator are located in the same physical entity, and the PPC may interact with a prepaid server (PPS). A prepaid agent (PPA) is located in a data plane entity, such as Anchor data path function (DPF), Serving DPF or base station (BS). In the following, it is exemplified that the PPA is located in the Anchor DPF.

An embodiment of the present invention provides a method for implementing prepaid accounting in a scenario of Anchor DPF migration. There may be two scenarios when an Anchor DPF migration occurs:

Scenario 1 The first Anchor DPF migration after a subscriber terminal initially assess to the network, at that time, the PPC is located in the data path and this scenario can be regarded as a special scenario in which the PPC and the PPA are located in the same physical entity.

Scenario 2 The subscriber terminal undergoes another Anchor DPF migration in a condition that the Anchor DPF is separated from the Authenticator, at that time, the PPC and the PPA are separated from each other.

The method for prepaid accounting in a scenario of Anchor DPF migration is described as follows by taking a PMIPv4 scenario as an example. Referring to FIG. 4, the method includes:

Step 401: In a pull mode, a target Anchor DPF sends an Anchor DPF relocation instruction to a source Anchor DPF. In case of push mode, this step can be omitted, and the flow enters into step 402 directly.

Step 402: The source Anchor DPF sends an Anchor DPF relocation request to the target Anchor DPF, the Anchor DPF relocation request carries quota information including one of the following: quota identifier (ID), quota, current quota usage, quota threshold, rating corresponding to a quota, service classifier corresponding to a quota and service flow information corresponding to a quota (including service flow ID or packet data flow ID), or a combination of any two or more of them. The Anchor DPF relocation request carries Anchor Mobility Management (MM) Context to be used in the Anchor DPF migration.

Steps 403-408: The process of Anchor DPF migration under normal PMIPv4 is performed. The target Anchor DPF sends an Anchor DPF migration request to a PMIP Client according to the Anchor MM Context. The PMIP Client returns an FA registration request message to the target Anchor DPF after verifying validity of the target Anchor DPF. The target Anchor DPF completes a mobile IP registration process for a new FA through steps 405-406 when receiving the FA registration request message. After obtaining a registration response, the target Anchor DPF returns an FA registration response message to the PMIP Client. Then, the target Anchor DPF notifies the source Anchor DPF that the migration is completed through step 408.

In the above steps, before the target Anchor DPF completes the mobile IP registration, data sent and received by the subscriber terminal is still transmitted through the source Anchor DPF. That is, after the transmission of quota information in step 402, the quota on the source Anchor DPF is still used, and the data is not switched to be transmitted through the target Anchor DPF until the registration of the target Anchor DPF is completed. The source Anchor DPF/PPA does not stop prepaid accounting management until the Anchor DPF relocation response message in step 408 is received. The target Anchor DPF/PPA starts prepaid accounting for downlink data after step 405, and starts prepaid accounting for uplink data after step 406.

Step 409: When receiving the Anchor DPF relocation response message sent by the target Anchor DPF, the source Anchor DPF returns an Anchor DPF relocation acknowledgement message to the target Anchor DPF. The Anchor DPF relocation acknowledgement message carries quota compensation information indicating the quota which is consumed by the subscriber terminal during the above relocation process, and the quota compensation information may be transmitted in a form of increment, or in a form of complete quota information as in step 402.

After receiving the quota compensation information, the target Anchor DPF/PPA updates the maintained prepaid quota with the quota compensation information. That is, target Anchor DPF/PPA deducts the quota consumed during the above relocation process from the maintained prepaid quota according to the quota compensation information.

After the PPC is separated from the PPA, the PPA functions as an execution point of prepaid accounting. According to the acquired quota information, the Anchor DPF located in the same entity as the PPA collects accounting data from service classifier and/or service flow corresponding to a quota in the quota information, and deducts the acquired quota. As an interface entity between the PPA and the PPS, the PPC maintains information required for interaction with the PPS, such as subscriber ID and quota ID.

As mentioned above, during the Anchor DPF migration, data is still transmitted via the source Anchor DPF in a period of time after the target Anchor DPF reports the quota information, and there may be two scenarios at that time: the quota reaches the threshold or the quota is exhausted.

Scenario 1: Quota usage reaches the threshold.

Mode 1: The source Anchor DPF/PPA no longer requests quota, but notifies the target Anchor DPF/PPA through the quota compensation information after the migration is completed. After obtaining the quota compensation information, the target Anchor DPF/PPA judges whether the quota usage reaches the threshold (but the quota is not exhausted). If the quota usage of the target Anchor DPF/PPA reaches the threshold, a quota request is initiated again to request a new quota. If the quota usage of the target Anchor DPF/PPA does not reach the threshold, the normal process is continued.

Mode 2: After detecting that the quota usage reaches the threshold, the source Anchor DPF immediately sends quota compensation information to the target Anchor DPF; after the target Anchor DPF receives the quota compensation information and judges that the quota usage has reached the threshold, the target Anchor DPF/PPA initiates a quota request process to acquire a new quota.

If the migration process of the target Anchor DPF fails, the target Anchor DPF notifies the source Anchor DPF/PPA of the newly acquired quota.

Mode 1 and Mode 2 can be combined. That is, the source Anchor DPF notifies the target Anchor DPF immediately after detecting that the threshold is reached, and the target Anchor DPF may delay the initiation of quota request until it is judged that the quota usage reaches the threshold after obtaining the quota compensation information.

Scenario 2: The Quota is Exhausted.

The scenario in which the quota is exhausted differs from the scenario in which the quota reaches the threshold. The difference lies in that in scenario 2, the target Anchor DPF/PPA directly sends a message to stop the service, instead of requesting a quota again.

Mode 1: The process as described above may be used. The target Anchor DPF/PPA judges that the quota is exhausted, and triggers the stop of the service, and the source Anchor DPF/PPA may discard any data beyond the quota.

Mode 2: During the relocation, when the source Anchor DPF detects that the quota is exhausted, the source Anchor DPF/PPA sends a notification carrying quota compensation information to notify the target Anchor DPF that the quota is exhausted. After judging that the quota is exhausted, the target Anchor DPF initiates a quota-exhausted process, such as triggering service flow release, or triggering subscriber network-exit.

Embodiments of the present invention further provide a method for implementing prepaid accounting when an Anchor DPF migration occurs in requesting a quota. This method is substantially same as that shown in FIG. 4 except the following differences:

After detecting that the quota usage reaches the threshold, the source Anchor DPF initiates a quota request to the PPS. The Anchor DPF relocation request carries quota information and an identifier for notifying the target Anchor DPF/PPA that a quota request has been initiated. The target Anchor DPF/PPA does not initiate a quota request according to the identifier. After obtaining a new quota, the source Anchor DPF carries new quota information in the quota compensation information to notify the target Anchor DPF/PPA.

If the source Anchor DPF/PPA fails to obtain a new quota in a response to the quota request, the process for handling the case that quota usage reaches the threshold or the quota is exhausted can be used.

An embodiments of the present invention provides a source PPA, which includes a sending module configured to send a relocation request carrying quota information to a target PPA, and a receiving module configured to receive a relocation response sent by the target PPA. After the receiving module receives the relocation response sent by the target PPA, the sending module sends a relocation acknowledgement message carrying quota compensation information to the target PPA.

An embodiment of the invention provides a system for implementing prepaid accounting on a network. The system includes: a source PPA configured to send a relocation request carrying quota information to a target PPA and receive a relocation response sent by the target PPA. After receiving the relocation response sent by the target PPA, the source PPA sends a relocation acknowledgement message carrying quota compensation information to the target PPA.

In summary, in the embodiments of the present invention, the source Anchor DPF/PPA sends an Anchor DPF relocation request carrying quota information to the target Anchor DPF/PPA. When receiving a relocation response, the source Anchor DPF/PPA returns an Anchor DPF relocation acknowledgement message to the target Anchor DPF/PPA. The Anchor DPF relocation acknowledgement message carries quota compensation information, so that prepaid service can be implemented in network.

An embodiment of the invention further provides a method for prepaid accounting in a scenario of Authenticator migration.

Because the PPC and the Authenticator are located in the same physical entity, migration of the PPC is the same as migration of the Authenticator. FIG. 5 shows migration of the Authenticator in the pull mode. For the push mode, the procedure is substantially the same except the triggering direction, and the detailed description is omitted here.

Steps 501-502: A target Authenticator sends a request to a source Authenticator, and obtains authentication context information of a subscriber terminal.

Step 503: The subscriber terminal performs a re-authentication process through the target Authenticator. When the re-authentication succeeds, the Authenticator for the subscriber terminal migrates to the target Authenticator.

Steps 504-506: After the subscriber terminal finishes the re-authentication process through the target Authenticator, the target Authenticator returns a migration success Ack to the source Authenticator.

As mentioned previously, as an interface for interaction between the PPA and the PPS, the PPC maintains information for communicating a quota request with the PPS, such as quota ID, rating ID, and service ID. With the migration of the Authenticator, the above information needs to migrate in accompany with the PPC. In step 505, the above information shall be carried, including quota ID, rating ID, and service ID. Meanwhile, as the PPC has migrated, the quota ID shall be kept to be valid, and therefore the quota ID is required to be valid within the range of the subscriber terminal.

In the embodiment as shown in FIG. 5, the scenario in which the PPC interacts with the PPS by using the Radius protocol is taken. Considering that the Diameter protocol can be used for the PPC to interact with the PPS, an embodiment of the present invention further provides a method for prepaid accounting in an Authenticator migration scenario. Because the Diameter protocol is different from the Radius protocol, a Diameter Session between the source PPC and the PPS shall be released after the PPC migrates, while a new Diameter Session shall be established between the target PPC and the PPS, and the release of the Diameter Session between the source PPC and the PPS shall not influence the current prepaid service of the subscriber terminal. Thus, in the present embodiment, a correlation between a new Diameter Session and the original Diameter Session is specified when the new Diameter Session is established, so that the PPS may transfer the prepaid service to the new Diameter Session directly.

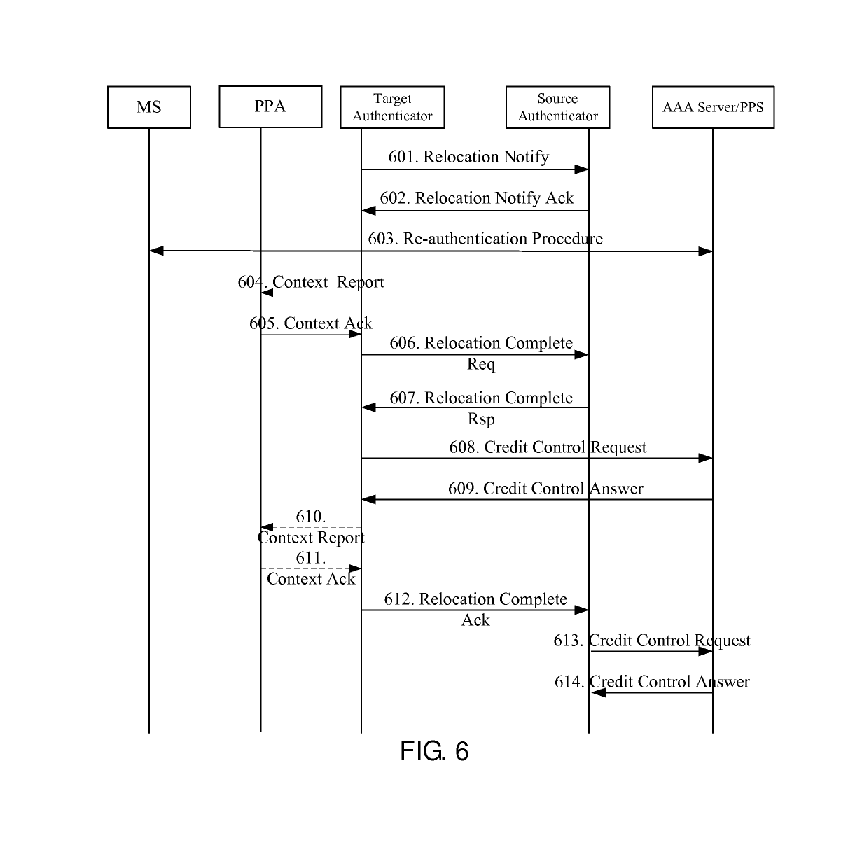

Because the PPC and the Authenticator are located in the same physical entity, migration of the PPC is the same as migration of the Authenticator. FIG. 6 shows a migration of Authenticator in the pull mode. For the push mode, the procedure is substantially the same except the triggering direction, and the detailed description is omitted here.

Steps 601-602: A target Authenticator/PPC sends a request to a source Authenticator/PPC, and obtains authentication context information of a subscriber terminal.

Step 603: The subscriber terminal performs a re-authentication process through the target Authenticator/PPC.

Step 604: When the re-authentication succeeds, the target Authenticator/PPC sends a Context Report message to a PPA to update Authenticator/PPC information maintained by the target Authenticator/PPC.

Step 605: The PPA returns, after updating the Authenticator/PPC information maintained by the PPA, to the target Authenticator/PPC a Context Ack message carrying quota information. The quota information includes one of the following: quota ID, quota, current quota usage, quota threshold, rating corresponding to a quota, information on service classifier corresponding to a quota and information on service flow corresponding to a quota (including service flow ID or packet data flow ID), or a combination of any two or more of them.

Step 606: The target Authenticator/PPC sends a Relocation Complete Req message to the source Authenticator/PPC to notify the source Authenticator/PPC that the re-authentication of the subscriber terminal is completed. The target Authenticator/PPC may determine whether or not to carry the quota information in the Relocation Complete Req message based on information, such as a policy.

Step 607: The source Authenticator/PPC returns a Relocation Complete Rsp message to the target Authenticator/PPC. The Relocation Complete Rsp message carries information on the current Diameter Session of the source Authenticator/PPC, and the information on Diameter Session is associated with the prepaid service. The information includes quota ID, session ID, CC-Correlation-ID, accounting session ID, service-ID, Service-Context-ID, Rating and service flow information corresponding to a quota (service flow ID or packet data flow ID), or a combination of any two or more of them.

Steps 608-609: With respect to each prepaid service, the target Authenticator/PPC sends a Credit Control Request message to a PPS to request establishment of a new Diameter Session. The Credit Control Request message carries the Diameter Session information of the source Authenticator/PPC obtained in step 607, and a correlation indication indicating that the new Diameter session to be established and the Diameter session of the source Authenticator/PPC are sessions correlated with the same prepaid service. After receiving the Credit Control Request message, the PPS transmits prepaid service information in the Diameter Session of the source Authenticator/PPC to the new Diameter Session of the target Authenticator/PPC, according to the Diameter Session information of the source Authenticator/PPC carried in the Credit Control Request message and the correlation indication. Meanwhile, the Credit Control Request message may also include the quota information obtained in step 605 for updating quota resources maintained on the PPS. The PPS returns a Credit Control Answer message to the target Authenticator/PPC to acknowledge that a new Diameter Session has been established. If the target Authenticator/PPC requests for updating the quota resources on the PPS, the Credit Control Answer message may carry a new quota indication including one of the following: Service-ID, Rating, Service-Context-ID, quota and quota threshold, or a combination of any two or more of them.

Steps 610-611: If in steps 608-609, the target Authenticator/PPC updates the quota resources on the PPS, the target Authenticator/PPC needs to distribute the obtained quota to the PPA. In the present embodiment, a Context Report/Ack message is taken as an example and the quota information is carried in the Context Report/Ack message. After obtaining the quota information, the PPA updates prepaid quota maintained thereby in consideration of the prepaid quota used in steps 605-611.

Step 612: The target Authenticator/PPC returns a Relocation Complete Ack message to the source Authenticator/PPC.

Steps 613-614: The source Authenticator/PPC sends a Credit Control Request message to the PPS to request release of a Diameter Session of the subscriber terminal corresponding to the prepaid service. The Credit Control Request message indicates that the prepaid service born by the Diameter Session is not ended but inherited by other session. It is not necessary for the PPS to release prepaid service context corresponding to the Diameter Session, nor to cancel prepaid quota assigned thereto. The PPS returns a Credit Control Answer message to the source Authenticator/PPC to acknowledge the release of the Diameter Session.

An embodiment of the invention provides a target PPC, which includes a notification message receiving module and a request message sending module.

The notification message receiving module is configured to receive a notification message sent by a source PPC and carrying session information of the source PPC associated with a prepaid service.

The request message sending is configured to send a request message to a PPS to request establishment of a new session, the request message carries the session information of the source PPC and a correlation indication indicating a correlation between the new session to be established and the session of the source PPC.

An embodiment of the invention provides a system for implementing prepaid accounting on a network, which includes a target PPC configured to receive a notification message sent by a source PPC and send a request message to a PPS to request establishment of a new session. The notification message carries session information of the source PPC associated with a prepaid service, and the request message carries the session information of the source PPC and a correlation indication indicating a correlation between the new session to be established and the session of the source PPC.

To sum up, in the embodiments of the present invention, when the Authenticator/PPC migrates, Diameter Session information associated with the prepaid service is transmitted between the source Authenticator/PPC and the target Authenticator/PPC. When the target Authenticator/PPC interacts with the PPS to establish a new Diameter Session, the target Authenticator/PPC indicates the correlation with the Diameter Session of the source Authenticator/PPC, so that the PPS can transfer the prepaid service information on the source Diameter Session to the new Diameter Session, which ensures the continuity of prepaid service of the subscriber terminal, and enables the prepaid service to be implemented on the network.

It is to be noted that the above description is merely for disclosure of the spirit of the present invention, but not for limiting scope of the present invention. Any amendment, equivalence and modification, etc. shall be deemed to be included in the scope of the present invention without deviating from the spirit and principle thereof.

What is claimed is:

1. A method for implementing prepaid accounting on a network, comprising:
sending, by a source Anchor data path function (DPF), an Anchor DPF relocation request carrying quota information to a target Anchor DPF; and
returning, by the source Anchor DPF, an Anchor DPF relocation acknowledgement message carrying quota compensation information to the target Anchor DPF, when receiving a relocation response sent by the target Anchor DPF.

2. The method according to claim 1, wherein the quota information comprises one of the following: quota ID, quota, current quota usage, quota threshold, rating corresponding to a quota, service classifier corresponding to a quota and service flow information corresponding to a quota, or a combination of any two or more of them.

3. The method according to claim 1, wherein the quota compensation information is transmitted in a form of increment or in a form of complete quota information.

4. A method for implementing prepaid accounting on a network, comprising:
sending, by a source prepaid agent (PPA), a relocation request carrying quota information to a target PPA; and
sending, by the source PPA, a relocation acknowledgement message carrying quota compensation information to the target PPA, when receiving a relocation response sent by the target PPA.

5. A method for implementing prepaid accounting on a network, comprising:
receiving, by a target prepaid client (PPC), a notification message sent by a source PPC, wherein the notification message carries session information of the source PPC associated with a prepaid service; and
sending, by the target PPC, a request message to a prepaid server (PPS) to request establishment of a new session, wherein the request message carries the session information of the source PPC and a correlation indication indicating a correlation between the new session to be established and the session of the source PPC.

6. The method according to claim 5, wherein the session information comprises one of the following: quota ID, session-ID, CC-Correlation-ID, account session-ID, service-ID, service-context-ID, Rating, and service flow information corresponding to the quota, or a combination of any two or more of them.

7. The method according to claim 5, wherein the correlation indication indicating the correlation between the new session to be established and the session of the source PPC indicates that the new session to be established and the session of the source PPC are sessions correlated with the same prepaid service.

8. The method according to claim 5, further comprising:
sending, by the target PPC, a report message to a prepaid agent (PPA) for updating PPC information maintained by the target PPC; and
receiving, by the target PPC, an acknowledgement message returned by the PPA, after the PPA updates the maintained PPC information, wherein the acknowledgement message carries quota information comprising one of the following: quota ID, quota, current quota usage, quota threshold, rating corresponding to a quota, service classifier corresponding to a quota and service flow information corresponding to a quota, or a combination of any two or more of them.

9. The method according to claim 8, wherein the request message further carries the quota information for updating quota resources maintained on the PPS.

10. The method according to claim 5, further comprising:
receiving, by he target PPC, an answer message acknowledging that a new session has been established returned by the PPS.

11. The method according to claim 10, wherein the answer message carries a quota indication comprising one of the following: service-ID, Rating, service-context-ID, quota and quota threshold, or a combination of any two or more of them.

12. A source prepaid agent (PPA), comprising:
a sending module configured to send a relocation request carrying quota information to a target PPA; and
a receiving module configured to receive a relocation response sent by the target PPA,
wherein the sending module is further configured to send a relocation acknowledgement message carrying quota compensation information to the target PPA, when receiving the relocation response sent by the target PPA.

13. The source PPA according to claim 12, wherein the quota information comprises one of the following: quota ID, quota, current quota usage, quota threshold, rating corresponding to a quota, service classifier corresponding to a quota and service flow information corresponding to a quota, or a combination of any two or more of them.

14. A target prepaid client (PPC), comprising:
a notification message receiving module configured to receive a notification message sent by a source PPC, wherein the notification message carries session information of the source PPC associated with a prepaid service; and
a request message sending module configured to send a request message to a PPS to request establishment of a new session, wherein the request message carries the session information of the source PPC and a correlation indication indicating a correlation between the new session to be established and the session of the source PPC.

15. The target PPC according to claim 14, wherein the session information comprises one of the following: quota ID, session-ID, CC-Correlation-ID, account session-ID, service-ID, service-context-ID, Rating, and service flow information corresponding to a quota, or a combination of any two or more of them.

16. The target PPC according to claim 14, wherein the correlation indication indicating the correlation between the new session currently to be established and the session of the source PPC indicates that the new session to be established and the session of the source PPC are sessions correlated with the same prepaid service.
